(19) United States
(12) Patent Application Publication
(10) Pub. No.: US 2016/0198895 A1
(43) Pub. Date: Jul. 14, 2016

(54) INDOOR GRILL APPLIANCE

(71) Applicant: General Electric Company, Schenectady, NY (US)

(72) Inventor: Darren Allen Turner, Louisville, KY (US)

(21) Appl. No.: 14/592,983

(22) Filed: Jan. 9, 2015

(51) Int. Cl. A47J 37/06

(52) U.S. Cl. CPC A47J 37/06

(57) ABSTRACT

An indoor grill and oven appliance is provided including a cabinet defining an oven cooking chamber with one or more oven heating elements configured to heat the oven cooking chamber. Positioned above the oven cooking chamber, the indoor grill and oven appliance includes one or more grill heating elements disposed within the cabinet and one or more grates. The one or more grates are in thermal communication with the one or more grill heating elements. A hood is disposed above the one or more grates and defines a substantially enclosed grill cooking chamber to facilitate indoor grilling operations while reducing a risk of damaging and/or dirtying indoor ceilings.

### FIELD OF THE INVENTION

The present subject matter relates generally to grill appliances, or more particularly to grill appliances capable of conducting grilling operations indoors.

### BACKGROUND OF THE INVENTION

Grilling has long been a popular form of cooking Typical grills generally include one or more heating elements disposed below a grilling surface. A top is removably positioned over the grilling surface, the top and the grilling surface together defining a grilling chamber. During grilling operations, cooking gases may be mostly trapped within the grilling chamber by the top. However, upon removal of the top, e.g., to examine food positioned on the grilling surface, to add or remove food to or from the grilling surface, or to reorient food positioned on the grilling surface, cooking gases are expelled to the atmosphere. The cooking gasses may include grease, smoke, or other fumes resulting from the grilling operations.

In order to avoid damage to, e.g., a ceiling of a kitchen, grills are operated outdoors or in other areas where the cooking gasses may be directly expelled from the cooking chamber to the atmosphere. However, in certain environments, outdoor grilling may not be convenient during all four seasons. For example, in certain environments, it may to too cold to comfortably grill outdoors during winter. Conversely, in certain environments, it may be too hot to comfortably grill outdoors during the summer. Additionally, other environmental conditions, such as rain, wind, snow, etc. may make it inconvenient to conduct grilling operations outdoors.

Accordingly, a grill suitable for indoor use would be useful. More specifically, a grill capable of containing cooking gases during cooking operations would be especially beneficial.

### BRIEF DESCRIPTION OF THE INVENTION

Aspects and advantages of the invention will be set forth in part in the following description, or may be apparent from the description, or may be learned through practice of the invention.

In a first exemplary embodiment, an indoor grill and oven appliance is provided. The indoor grill and oven appliance defines a vertical direction and includes a cabinet defining an oven cooking chamber, one or more oven heating elements configured to heat the oven cooking chamber, and one or more grill heating elements. The one or more grill heating elements are disposed within the cabinet and positioned above the oven cooking chamber along the vertical direction. The indoor grill and oven appliance additionally includes one or more grates in thermal communication with the one or more grill heating elements, and a hood disposed above the one or more grates along the vertical direction. The hood defines a substantially enclosed grill cooking chamber.

In a second exemplary embodiment, an indoor grill and oven appliance is provided. The indoor grill and oven appliance includes a cabinet defining an oven cooking chamber and an air exhaust, one or more oven heating elements configured to heat the oven cooking chamber, and one or more grill heating elements. The one or more grill heating elements are disposed within the cabinet and positioned above the oven cooking chamber along the vertical direction. The indoor grill and oven appliance additionally includes one or more grates in thermal communication with the one or more grill heating elements and defines a planar grilling surface. Further, the indoor grill and oven appliance includes a hood positioned adjacent to the one or more grates to define a grill cooking chamber. The air exhaust defined by the cabinet is in flow communication with the grill cooking chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an indoor grill and oven appliance in accordance with an exemplary embodiment of the present subject matter.

FIG. 2 provides another perspective view of the exemplary indoor grill and oven appliance of FIG. 1.

FIG. 3 provides a close up perspective view of a grilling portion of the exemplary indoor grill and oven appliance of FIG. 1.

FIG. 4 provides a cross-sectional view of the grilling portion of the exemplary indoor grill and oven appliance of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

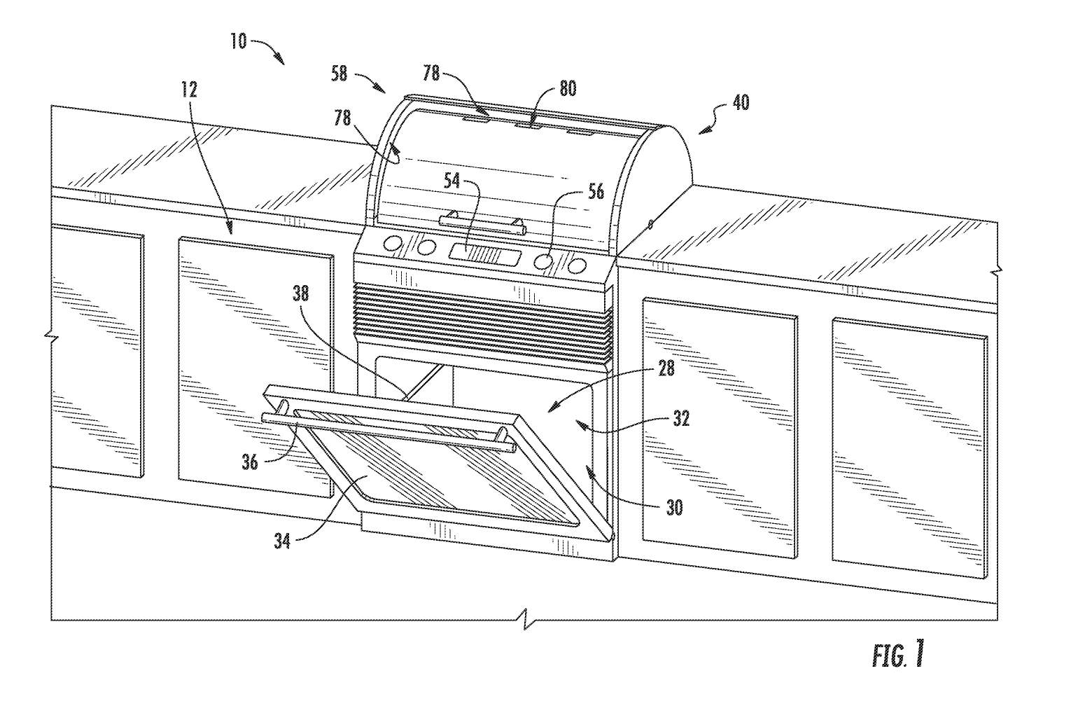

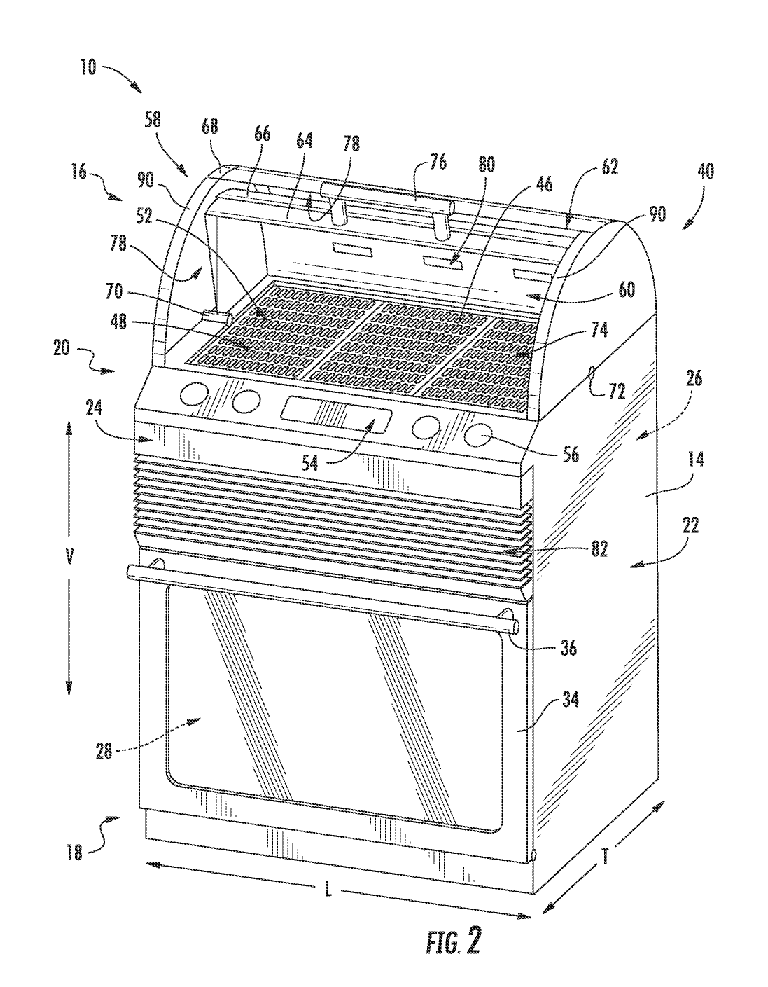

Referring now to the drawings, FIGS. 1 and 2 provide perspective views of an indoor grill and oven range appliance 10 in accordance with an exemplary embodiment of the present subject matter. More particularly, FIG. 1 provides a perspective view of indoor grill and oven range appliance 10 integrated into cabinets 12 of a kitchen, with an oven door 34 in an open position. Additionally, FIG. 2 provides a perspective view of indoor grill and oven appliance 10 with a hood door 64 in an open position. As will be explained in greater detail below, it should be understood that indoor grill and oven appliance 10 is provided by way of example only and is not intended to limit the present subject matter in any aspect.

As may be seen in FIGS. 1 and 2, indoor grill and oven appliance 10 defines a vertical direction V, a lateral direction L, and a transverse direction T. The vertical, lateral, and transverse directions V, L, and T are mutually perpendicular and form an orthogonal direction system. Indoor grill and oven appliance 10 includes a cabinet 14. Cabinet 14 extends between a top portion 16 and a bottom portion 18 along the vertical direction V; between a first side 20 and a second and opposite side 22 along the lateral direction L; and between a front side 24 and a rear side 26 along the transverse direction T.

Cabinet 12 defines an interior oven cooking chamber 28 and an oven cooking chamber opening 30. Oven cooking chamber 28 is defined by an interior surface 32 of cabinet 14 and is configured for receipt of one or more food items to be cooked. Oven cooking chamber opening 30 is positioned at front side 24 of cabinet 14 and permits access to oven cooking chamber 28 of cabinet 14. Indoor grill and oven appliance 10 also includes an oven door 34 rotatably mounted to cabinet 14, e.g., with a hinge (not shown). Oven door 34 is positioned at or adjacent to oven cooking chamber opening 30 of cabinet 14 and is selectively moveable between an open position (FIG. 1) and a closed position (FIG. 2). With oven door 34 in the open position, a user can access oven cooking chamber 28 of cabinet 14 through opening 30 of cabinet 14. Conversely, oven door 34 hinders or prevents access to oven cooking chamber 28 of cabinet 14 through opening 30 of cabinet 14 when oven door 34 is in the closed position. An oven handle 36 is mounted to oven door 34 and may assist a user with shifting oven door 34 between the open and closed positions in order to access oven cooking chamber 28. For example, a user can pull on handle 36 to adjust oven door 34 from the closed position to the open position and access oven cooking chamber 28.

Indoor grill and oven appliance 10 additionally includes a plurality of mounting features 38 for receiving one or more oven racks (not shown) within oven cooking chamber 28. More particularly, the exemplary indoor grill and oven appliance 10 includes embossed ribs or sliding rails such that the one or more oven racks may be conveniently moved into and out of oven cooking chamber 28 when oven door 34 is open. The one or more oven racks may be used to hold or support one or more food items and/or cooking utensils when positioned on the sliding rails within the cooking chamber 28.

One or more oven heating elements are provided to heat the oven cooking chamber 28. For example, a bake or bottom heating element (not shown) may be positioned in cabinet 14, e.g., at a bottom end of oven cooking chamber 28. Bottom heating element may be used to heat oven cooking chamber 28 for both cooking and cleaning of indoor grill and oven appliance 10. The size and heat output of bottom heating element can be selected based on the e.g., the size of indoor grill and oven appliance 10. Bottom heating element can be any suitable heating element. For example, bottom heating element may be an electric resistance heating element, a gas burner, a microwave heating element, etc.

The one or more oven heating elements may also include a broil or top heating element (also not shown) positioned in cooking chamber 28 of cabinet 14, e.g., at a top end of the cooking chamber 28. Top heating element may be used to heat cooking chamber 28 for both cooking/broiling and cleaning of indoor grill and oven appliance 10. Like bottom heating element, the size and heat output of top heating element can be selected based on e.g., the size of indoor grill and oven appliance 10. Top heating element can be any suitable heating element. For example, top heating element may be an electric resistance heating element, a gas burner, a microwave heating element, etc.

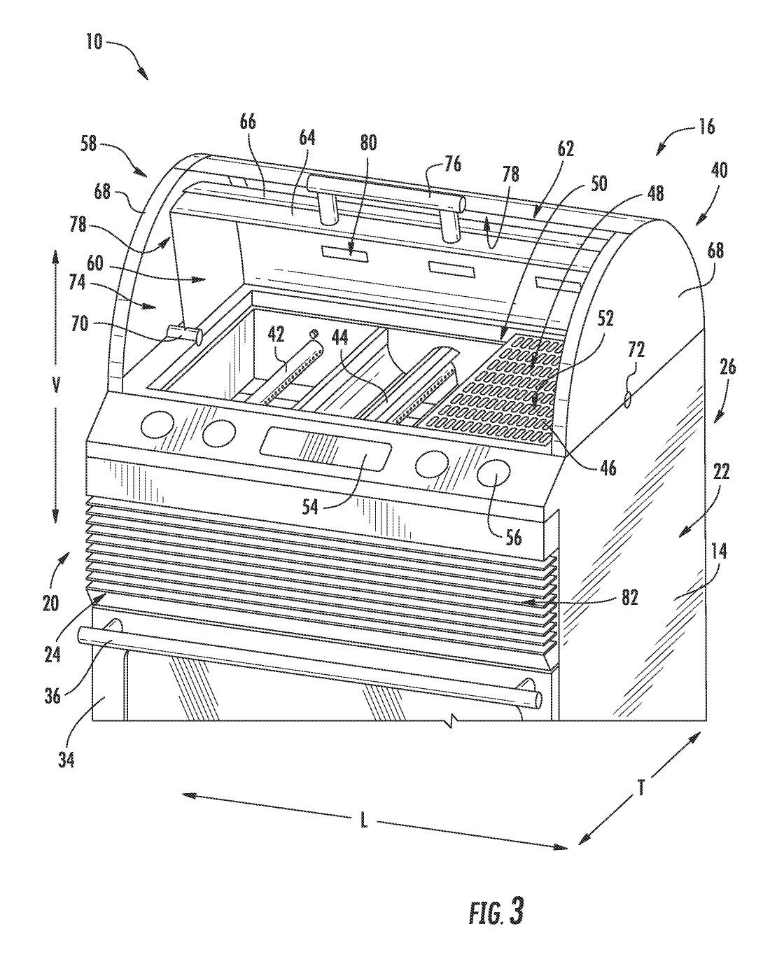

Reference will now additionally be made to FIG. 3. FIG. 3 provides a close-up view of indoor grill and oven appliance 10, with certain components removed for clarity. As shown in FIGS. 1 through 3, indoor grill and oven appliance 10 also includes a grill portion 40 positioned generally at the top end 16 of indoor grill and oven appliance 10. More particularly, indoor grill and oven appliance 10 also includes one or more grill heating elements 42 (FIG. 3) disposed within the cabinet and positioned above oven cooking chamber 28 along the vertical direction V. For the embodiment depicted, the one or more grill heating elements 42 are each gas burners extending linearly along the transverse direction T. More particularly, for the embodiment depicted, the one or more grill heating elements 42 include at least three (3) gas burners. Gas burners may be connected with an outside gas source through one or more conduits (not shown). During grilling operations, a combustible gas may flow through a plurality of nozzles or openings on the gas burners and be ignited to provide heat for the grilling portion 40.

Additionally, the exemplary indoor grill and oven appliance 10 includes shields 44 extending over each of the one or more grill heating elements 42. Shields 44 may protect the grill heating elements 42 from, e.g., fluids and/or particles of food. Shields 44 may additionally assist with more evenly distributing heat from the one or more grill heating elements 42.

Indoor grill and oven appliance 10 additionally includes one or more grates 46 in thermal communication with the one or more grill heating elements 42. For the embodiment depicted, the one or more grates 46 are disposed above the one or more grill heating elements 42 along the vertical direction V and together define a planar grilling surface 48 continuously extending over each of the one or more grill heating elements 42. As used herein, the term “planar” refers to extending generally in a plane defined by the lateral and transverse directions L, T.

Additionally, for the embodiment depicted in FIGS. 2 and 3, at least three (3) grates 46 are provided, each defining a substantially rectangular shape and each configured to rest on an inner ledge 50 defined by cabinet 14. Each of the one or more grates 46 may be configured to directly receive one or more food items in order to grill the one or more food items. Accordingly, each of the one or more grates 46 define a plurality of openings 52, allowing the one or more food items to be cooked using radiant heat from the one or more grill heating elements 42, as well as with conductive heat from the one or more grates 46.

It should be appreciated, however, that in other exemplary embodiments, any other suitable type, number, and/or configuration of grill heating elements 42 and/or grates 46 may be provided. For example, in other exemplary embodiments, the one or more grill heating elements 42 for indoor grill and oven appliance 10 may additionally or alternatively include contact electric heating elements, infrared heating elements, or elements configured to receive solid fuel sources (such as, charcoal, woodchips, etc.). Notably, when the one or more grill heating elements 42 are, e.g., electric contact heating elements, the one or more grill heating elements 42 and be one or more grates 46 may be integrated. Moreover, in other exemplary embodiments the one or more grill heating elements 42 may instead be configured to extend linearly along the lateral direction L generally between the first and second sides 20, 22 of appliance 10 and the one or more grates 46 may instead be configured as elongated wires extending between, e.g., a perimeter frame. Further, in other exemplary embodiments, the indoor grill and oven appliance 10 may include any suitable number of grill heating elements 42 and/or grates 46. For example, in certain exemplary embodiments, appliance 10 may include at least two grill heating elements 42 and/or at least two grates 46, may include at least four grill heating elements 42 and/or at least four grates 46, or may include at least six grill heating elements 42 and/or at least six grates 46.

The operation of indoor grill and oven appliance 10, including the one or more oven heating elements and one or more grill heating elements 42, is controlled by one or more processing devices (not shown) such as a microprocessor or other device that is in operable communication with such components. Such processing device (used herein to refer generally to single and/or multiple processing devices) may also be in operable communication with other components of appliance 10, such as a fan 88 and a bypassed vent 92 (each discussed below). Further, such processing device may be in operable communication with a control panel 54 having a plurality of user inputs 56 and, e.g., temperature sensors (not shown) that are used to measure a temperature inside oven cooking chamber 28 and/or a temperature inside a grill cooking chamber 60 (discussed below). Control panel 54 provides visual information to a user and allows a user to select various options for the operation of indoor grill and oven appliance 10 via user inputs 56. One or more of a variety of electrical, mechanical or electro-mechanical input devices including rotary dials, push buttons, toggle/rocker switches, and/or touch pads can also be used singularly or in combination as user inputs 56.

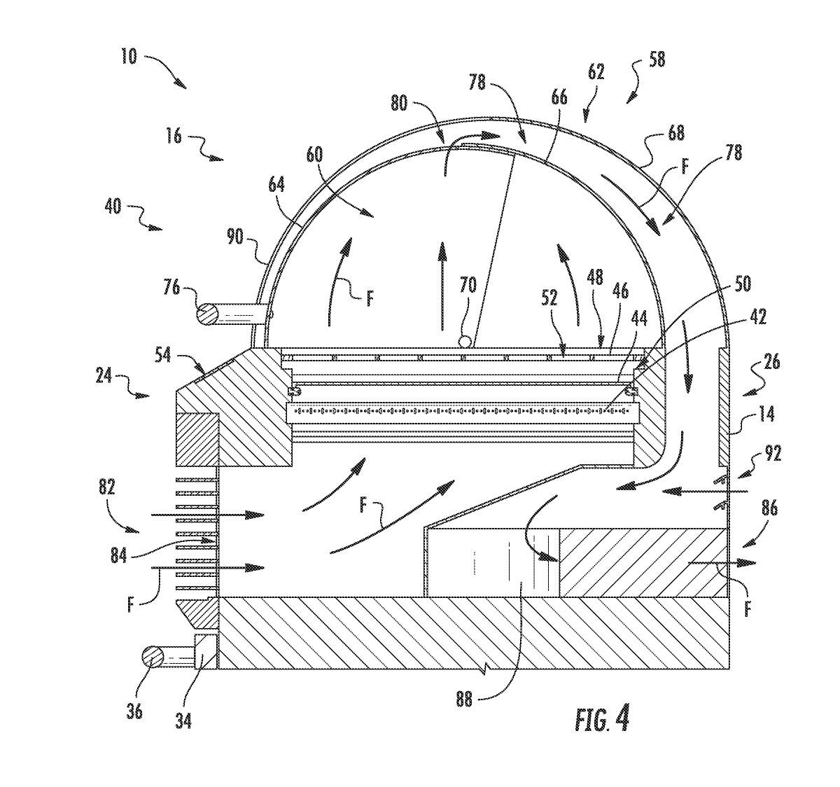

Referring still to FIGS. 1 through 3, the indoor grill and oven appliance 10 further includes a hood assembly 58. For the embodiment depicted, hood assembly 58 is disposed above the one or more grates 46 and defines a grill cooking chamber 60 with the one or more grates 46. More particularly, the hood assembly 58 is positioned at top end 16 of appliance 10, adjacent to the one or more grates 46 to define a substantially enclosed grill cooking chamber 60. Hood assembly 58 depicted is attached to or integral with cabinet 14 and defines a semicircular cross-sectional shape (as viewed along the lateral direction L, see FIG. 4) to substantially enclose the grill cooking chamber 60. More particularly, hood assembly 58 includes a base portion 62 and a door 64. Base portion 62 of hood assembly 58 includes an inner liner 66 in an outer liner 68. Outer liner 68 for the embodiment depicted is attached to cabinet 14, although in other embodiments, outer liner 68 may instead be formed integrally with cabinet 14.

Door 64 of hood assembly 58 is moveable relative to base portion 62. More particularly, for the embodiment depicted, hood door 64 defines a complementary shape with inner liner 66 of base portion 62 of hood assembly 58 and pivots about a first attachment hinge 70 and a second attachment hinge 72 between an open position (FIGS. 2 and 3) and a closed position (FIG. 1).

When hood door 64 is in the open position, hood door 64 is nested within inner liner 66 of base portion 62 of hood assembly 58. However, in other embodiments, inner liner 66 may instead be nested within hood door 64 when hood door 64 is in the open position. Moreover, when hood door 64 is moved to the open position, a grill cooking chamber opening 74 defined by hood assembly 58 is exposed (FIGS. 2 and 3), permitting a user to access grill cooking chamber 60. By contrast, when hood door 64 in the closed position (FIG. 1), hood door 64 prevents access to grill cooking chamber 60 through grill cooking chamber opening 74 and hood assembly 58 substantially encloses grill cooking chamber 60. It should be appreciated, that as used herein, the term “substantially enclose” refers to defining an identifiable space with enclosures on all sides, regardless of whether such enclosures allow for a flow of air therethrough or therebetween. A hood door handle 76 is provided to assist a user with moving hood door 64 between the open and closed positions.

Base 62 of hood assembly additionally defines a vent 78. More particularly, inner and outer liners 66, 68 of base 62 of hood assembly 58 together define vent 78. As shown, for the embodiment depicted, vent 78 extends from top 16 of appliance 10 (or more particularly, of hood assembly 58) towards rear side 26 of appliance 10. Additionally, vent 78 extends around inner liner 66 of base 62 of hood assembly 58 at first and second sides 20, 22 of appliance 10. Moreover, as depicted, hood door 64 defines a plurality of openings 80 at a top of door 64 configured to allow an airflow F therethrough and into vent 78 (see FIG. 4). However, in other embodiments, inner liner 66 of hood assembly 58 may additionally or alternatively define the plurality of openings 80. Although not depicted, one or more mechanisms may be provided in order to adjust a size of the one or more openings 80 during grilling operations.

Referring still to FIGS. 1 through 3, cabinet 14 further defines an air intake 82 positioned at front end 24 of appliance 10 and below the one or more grates 46 and the one or more grill heating elements 42 along the vertical direction V. Air intake 82 is configured to provide the one or more grill heating elements 42 with air, e.g., for combustion. For the embodiment depicted, air intake 82 is configured as a plurality of openings 84 extending along the lateral direction L between first side portion 20 and second side portion 22 of appliance 10. However, in other exemplary embodiments, any other suitable configuration for air intake 82 may be provided and air intake 82 may be positioned at any other suitable location (e.g., on one or both of first side 20 and second side 22 of appliance 10). Alternatively, in certain exemplary embodiments, for example when the one or more grill heating elements 42 are electrical heating elements, cabinet 12 may not define an air intake 82. Additionally, although not depicted, in certain exemplary embodiments, appliance 10 may further include an air filter adjacent to air intake 82 to reduce a risk of any particles or other debris from reaching grill cooking chamber 60 of appliance 10.

Referring now to FIG. 4, a cross-sectional view of exemplary indoor grill and oven appliance 10 is provided. As shown, the exemplary indoor grill and oven appliance 10 includes means for capturing and exhausting air from within grill cooking chamber 60.

More particularly, an airflow F may enter grill portion 40 of appliance 10 through air intake 82 at front 24 of appliance 10. Airflow F from air intake 82 may be provided to the one or more grill heating elements 42. For example, in the exemplary embodiment depicted, wherein the one or more grill heating elements 42 are gas burners, airflow F from air intake 82 may be provided to the one or more gas burners to facilitate combustion during grilling operations such that the one or more grill heating elements 42 may heat the one or more grates 46 and/or grill any food positioned thereon. Accordingly, during grilling operations, combustion gasses and fumes caused by grilling one or more food items positioned on the one or more grates (i.e., cooking gases) may be generated and contained within the airflow F through the grill portion 40 of appliance 10.

When hood door 64 is in the closed position, as is depicted in FIG. 4, airflow F, including cooking gases, from grill cooking chamber 60 may pass through the one or more openings 80 at top of hood door 64. From the one or more openings 80, the airflow F, including cooking gases, may then pass into vent 78 defined by base 62 of hood assembly 58. Vent 78 is configured to capture the airflow F, including the cooking gases, from the grill cooking chamber 60. Accordingly, the one or more openings 80 may allow the airflow F to flow from grill cooking chamber 60 into vent 78 when hood door 64 is in the closed position.

For the embodiment depicted, vent 78 extends along an outer portion of top side 16 and rear end 26 of appliance 10 towards an air exhaust 86 defined by cabinet 14 at rear end 26 of appliance 10. Air exhaust 86 is therefore in fluid communication with grill cooking chamber 60 through vent 78. For the embodiment depicted, air exhaust 86 is positioned below the one or more grill heating elements 42 and below the one or more grates 46 of appliance 10 along the vertical direction V. However, in other embodiments, air exhaust 86 may instead be positioned in-line with the one or more grates 46 and/or the one or more grill heating elements 42 along the vertical direction V. Although not depicted, air exhaust 86 may be attached to ductwork leading to a suitable ambient location (e.g., an outside location).

Referring still to FIG. 4, appliance 10 further includes a fan 88 positioned within the cabinet 14. Fan 88 is in fluid communication with vent 78 of hood assembly 58 and is configured to urge the airflow F through vent 78 of hood assembly 58 and out air exhaust 86 defined by cabinet 14. Fan 88 may therefore assist vent 78 of hood assembly 58 in capturing the airflow F, including the cooking gases, from grill cooking chamber 60 during grilling operations. For example, when hood door 64 is in the closed position (see FIG. 1), fan 88 may pull air through vent 78 such that air exhausting through the one or more openings 80 in hood door 64 flows through vent 78 and out air exhaust 86. Additionally, when hood door 64 is in the open position (see FIGS. 2 and 3), fan 88 may pull a sufficient amount of air through vent 78 of hood assembly 58 such that substantially all of the airflow F, including the cooking gases, from grill cooking chamber 60 flows through vent 78 of hood assembly 58. Such a configuration may assist hood assembly 58, or more particularly vent 78 of hood assembly 58, in capturing the airflow F, including cooking gases, from grill cooking chamber 60.

Additionally, for the embodiment depicted, hood assembly 58, or more particularly, outer liner 68 of base 62 of hood assembly 58, includes lips 90 extending inwardly along the lateral direction L at first and second sides 20, 22 of appliance 10 proximate to front side 24 of appliance 10 (see FIGS. 1 through 3). Inwardly extending lips 90 assist in directing the airflow F, including cooking gases, from grill cooking chamber 60 into vent 78 of hood assembly 58.

As is also depicted in FIG. 4, cabinet 14 further defines a bypass vent 92 positioned at rear side 26 of appliance 10 adjacent to air exhaust 86. Bypass vent 92 is configured to provide an additional flow of air to fan 88 and may be adjustable, such that a variable amount of air may be provided to the fan 88. Such a configuration may allow for appliance 10 to include a fan 88 larger than is necessary to capture air from grill cooking chamber 60. Such may be necessary in order to provide the necessary airflow to push air through an extended length of ductwork (not shown) to a suitable ambient position. Inclusion of bypass vent 92 may ensure indoor grill and the oven appliance 10 does not pull more air through, e.g., cooking chamber 60 than is necessary, preventing unnecessary removal of heat from the one or more grill heating elements 42, the one or more grates 46, and any food positioned within grill cooking chamber 60.

An indoor grill and oven appliance 10 in accordance with the present disclosure may therefore allow for indoor grilling of one or more food items without having cooking gases expel into a room in which the appliance 10 is positioned (minimizing a risk of damaging and/or dirtying walls and a ceiling of such room). Additionally, with the above configuration, the airflow F through the appliance 10, or more particularly the air from air intake 82 and through the grill cooking chamber 60 into vent 78, may be configured to flow at a rate which prevents more heat than is necessary from being transferred from the grill heating elements 42 and grill cooking chamber 60 to the airflow F (and away from, e.g., the one or more grill heating elements 42, the one or more grates 46, and/or the one or more food items being grilled).

It should be appreciated, however, that the exemplary indoor grill and oven appliance 10 depicted is provided by way of example only. For example, in other exemplary embodiments, indoor grill and oven appliance 10 may further include one or more filter assemblies positioned in or adjacent to, e.g., vent 78 of air intake 82 and/or air exhaust 86. With such an exemplary embodiment, airflow F from air exhaust 86 may be redirected into the room in which appliance 10 is positioned. Moreover, in other exemplary embodiments, bypass vent 92 may pull air from any suitable location. For example, in certain embodiments, bypass vent 92 may pull air from front 24 and/or sides 20, 22 of appliance 10. In such an embodiment, bypass vent 92 may additionally provide cooling of certain outside surfaces of cabinet 14 of appliance 10. Furthermore, although appliance 10 is depicted including an oven cooking chamber 28, in other exemplary embodiments, appliance 10 may not include oven cooking chamber 28. Accordingly, in certain exemplary embodiments appliance 10 may not be an indoor grill and oven appliance, and instead may simply be an indoor grill appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An indoor grill and oven appliance defining a vertical direction, the appliance comprising:
a cabinet defining an oven cooking chamber;
one or more oven heating elements configured to heat the oven cooking chamber;
one or more grill heating elements disposed within the cabinet and positioned above the oven cooking chamber along the vertical direction;
one or more grates in thermal communication with the one or more grill heating elements; and
a hood disposed above the one or more grates along the vertical direction and defining a substantially enclosed grill cooking chamber.

2. The indoor grill and oven appliance of claim 1, wherein the one or more grill heating elements are gas burners.

3. The indoor grill and oven appliance of claim 1, wherein the cabinet defines an air intake positioned at a front of the appliance and below the one or more grill heating elements along the vertical direction, the air intake configured to provide the one or more grill heating elements with air.

4. The indoor grill and oven appliance of claim 1, wherein the indoor grill and oven appliance further defines a transverse direction, wherein the one or more grill heating elements extend linearly along the transverse direction.

5. The indoor grill and oven appliance of claim 1, wherein the indoor grill and oven appliance further defines a lateral direction, wherein the one or more grill heating elements extend linearly along the lateral direction.

6. The indoor grill and oven appliance of claim 1, wherein the one or more grill heating elements includes at least three grill heating elements.

7. The indoor grill and oven appliance of claim 1, wherein the cabinet further defines an air exhaust in flow communication with the grill cooking chamber.

8. The indoor grill and oven appliance of claim 1, wherein the one or more grates together define a planar grilling surface continuously extending over each of the one or more grill heating elements.

9. The indoor grill and oven appliance of claim 1, further comprising
an oven door, wherein the cabinet further defines an oven opening permitting access to the oven cooking chamber, and wherein the oven door is disposed over the oven opening.

10. The indoor grill and oven appliance of claim 1, wherein the hood is attached to or integral with the cabinet, and wherein the hood defines a semicircular cross-sectional shape to substantially enclose the grill cooking chamber.

11. The indoor grill and oven appliance of claim 1, wherein the hood includes a base and a door, wherein the door is movable relative to the base.

12. The indoor grill and oven appliance of claim 1, wherein the grates are positioned above the grill heating elements along the vertical direction.

13. An indoor grill and oven appliance comprising:
a cabinet defining an oven cooking chamber and an air exhaust;
one or more oven heating elements configured to heat the oven cooking chamber;
one or more grill heating elements disposed within the cabinet and positioned above the oven cooking chamber along the vertical direction;
one or more grates in thermal communication with the one or more grill heating elements and defining a planar grilling surface;
a hood positioned adjacent to the one or more grates to define a grill cooking chamber, the air exhaust defined by the cabinet in flow communication with the grill cooking chamber.

14. The indoor grill and oven appliance of claim 13, wherein the one or more grill heating elements are gas burners.

15. The indoor grill and oven appliance of claim 13, wherein the indoor grill and oven appliance defines a vertical direction, wherein the cabinet defines an air intake positioned at a front of the appliance and below the grates along the vertical direction, the air intake configured to provide the one or more grill heating elements with air.

16. The indoor grill and oven appliance of claim 13, wherein the indoor grill further defines a transverse direction, wherein the one or more grill heating elements extend linearly along the transverse direction.

17. The indoor grill and oven appliance of claim 13, wherein the indoor grill and oven appliance further defines a lateral direction, wherein the one or more grill heating elements extend linearly along the lateral direction.

18. The indoor grill and oven appliance of claim 13, wherein the planar grilling surface defined by the one or more grates continuously extends over each of the one or more grill heating elements.

19. The indoor grill and oven appliance of claim 13, wherein the hood defines a semicircular cross-sectional shape and is attached to or integral with the cabinet.

20. The indoor grill and oven appliance of claim 13, wherein the hood includes a base and a door, wherein the door is movable relative to the base.
